(19) United States
(12) Patent Application Publication
(10) Pub. No.: US 2024/0360579 A1
(43) Pub. Date: Oct. 31, 2024

(54) PLATING MATERIAL, AND TERMINAL-EQUIPPED ELECTRIC WIRE, CONNECTOR, AND WIRE HARNESS USING THE SAME

(71) Applicant: Yazaki Corporation, Tokyo (JP)

(72) Inventors: Nobuyuki TAMURA, Shizuoka (JP); Dai NAKATSUKA, Shizuoka (JP); Takuma ISHII, Shizuoka (JP)

(73) Assignee: Yazaki Corporation, Tokyo (JP)

(21) Appl. No.: 18/645,605

(22) Filed: Apr. 25, 2024

(30) Foreign Application Priority Data
Apr. 28, 2023 (JP) 2023-074447

(51) Int. Cl. C25D 3/46; C22C 5/06; C25D 3/12; C25D 5/34; C25D 7/06

(52) U.S. Cl. CPC C25D 3/46; C22C 5/06; C25D 3/12; C25D 5/34; C25D 7/0607

(57) ABSTRACT

A plating material includes a metal base material and a silver-tin alloy plating layer being arranged on the metal base material and containing a silver-tin alloy. Further, the silver-tin alloy plating layer contains crystal grains of Ag₃Sn, and a ratio of grains of Sn per observed area is equal to or greater than 2.0% and equal to or less than 11.0% when the crystal grains of Ag₃Sn are arranged isotropically, and a cross-section of the silver-tin alloy plating layer is observed with an FE-SEM.

### CROSS REFERENCE TO RELATED APPLICATIONS

The present application is based on, and claims priority from the prior Japanese Patent Application No. 2023-074447, filed on Apr. 28, 2023, the entire contents of which are incorporated herein by reference.

### TECHNICAL FIELD

The present disclosure relates to a plating material, and a terminal-equipped electric wire, a connector, and a wire harness using the same.

### BACKGROUND

In recent years, there has been a growing demand for hybrid vehicles and electric vehicles, and such vehicles use high-power motor, resulting in the flow of large currents and significant heat generation in their wiring lines and terminals. Thus, silver plating with low heat generation is used for terminals in those vehicles. Moreover, charging connectors used in hybrid vehicles and electric vehicles undergo repeated insertions and withdrawals, and hence abrasion resistance is desired. Thus, hard silver plating with improved abrasion resistance is used for the terminals.

Even in hard silver plating, the Vickers hardness thereof is approximately Hv140. Therefore, to further improve abrasion resistance, increasing the thickness of the plating layer and applying silver-tin plating, which has higher hardness than hard silver plating as disclosed in Japanese Patent No. 6172811, have been disclosed.

### SUMMARY OF THE INVENTION

Meanwhile, charging connectors used in hybrid vehicles and electric vehicles require environmental resistance. However, silver-tin plating has a problem where silver is precipitated on a surface (Ag migration) after exposure to high temperature and high humidity environments or saltwater spray.

The present disclosure has been achieved in view of the above-mentioned problem in such a related-art. Further, the present disclosure has an object to provide a plating material, and a terminal-equipped electric wire, a connector, and a wire harness using the same that have improved environmental resistance.

The plating material according to an aspect of the present disclosure includes a metal base material and a silver-tin alloy plating layer being arranged on the metal base material and containing a silver-tin alloy, wherein the silver-tin alloy plating layer contains crystal grains of Ag₃Sn, and a ratio of grains of Sn per observed area is equal to or greater than 2.0% and equal to or less than 11.0% when the crystal grains of Ag₃Sn are arranged isotropically, and a cross-section of the silver-tin alloy plating layer is observed with an FE-SEM.

According to the present disclosure, it is possible to provide a plating material, and a terminal-equipped electric wire, a connector, and a wire harness using the same that have improved environmental resistance.

### BRIEF DESCRIPTION OF DRAWINGS

FIG. 1 is a schematic view illustrating one example of a plating material according to the present embodiment.

FIG. 2 is a schematic view illustrating one example of the plating material according to the present embodiment.

FIG. 3A is a field emission scanning electron microscope (FE-SEM) photograph illustrating a cross-section of a silver-tin alloy plating layer in an enlarged manner when crystal grains of Ag₃Sn are arranged isotropically.

FIG. 3B is a field emission scanning electron microscope (FE-SEM) photograph illustrating a cross-section of a silver-tin alloy plating layer in an enlarged manner when crystal grains of Ag₃Sn are arranged in a columnar structure.

FIG. 4A is a photograph of a surface of a silver-tin alloy plating layer after subjecting a test piece to a high-temperature and high-humidity test and a saltwater spray test, the test piece having the silver-tin alloy plating layer in which crystal grains of Ag₃Sn are arranged isotropically.

FIG. 4B is a photograph of a surface of a silver-tin alloy plating layer after subjecting a test piece to a high-temperature and high-humidity test and a saltwater spray test, the test piece having the silver-tin alloy plating layer in which crystal grains of Ag₃Sn are arranged in a columnar structure.

FIG. 5 is a perspective view illustrating one example of a terminal-equipped electric wire according to the present embodiment before an electric wire is crimped with a terminal.

FIG. 6 is a perspective view illustrating one example of a terminal-equipped electric wire according to the present embodiment after an electric wire is crimped with a terminal.

FIG. 7 is a perspective view illustrating one example of a wire harness according to the present embodiment.

FIG. 8A is an FE-SEM photograph (25,000× magnification) showing a cross-section of a silver-tin alloy plating layer in Example 1 in an enlarged manner.

FIG. 8B is an FE-SEM photograph (25,000× magnification) showing a cross-section of a silver-tin alloy plating layer in Example 2 in an enlarged manner.

FIG. 8C is an FE-SEM photograph (25,000× magnification) showing a cross-section of a silver-tin alloy plating layer in Comparative Example 1 in an enlarged manner.

### DETAILED DESCRIPTION OF THE INVENTION

With reference to the drawings, a plating material, a terminal using the same, an electric wire including the terminal, a connector, and a wire harness according to the present embodiment are described below in detail. Note that the dimensions in the drawings may be exaggerated for explanatory purposes, and may not reflect the actual proportions.

### Plating Material 1

A plating material 1 according to the present embodiment includes a metal base material 2 and a silver-tin alloy plating layer 3 being arranged on the metal base material 2 and containing a silver-tin alloy. Thus, the plating material 1 according to the present embodiment has lower electrical resistance compared to tin plating in the related art, and hence heat generation is less likely to occur even in a location with a high current flow, such as a hybrid vehicle or an electric vehicle.

Further, the silver-tin alloy plating layer 3 contains an intermetallic compound of silver and tin. Further, the Vickers hardness of the surface of the silver-tin alloy plating layer 3 in the plating material 1 is preferably equal to or greater than 180 Hv and equal to or less than 310 Hv. Thus, the plating material 1 according to the present embodiment has high abrasion resistance. When the plating material 1 is used as a terminal, the plating layer is resistant to abrade even after repeated insertions and withdrawals of the terminal. Thus, contact resistance can be reduced, heat generation can be suppressed when used as a terminal, and power consumption can be reduced. Details of each configuration of the present embodiment are described below.

### Metal Base Material 2

The metal base material 2 is a plated material being subjected to plating with the silver-tin alloy plating layer 3. As a material for forming the metal base material 2, metal having high conductivity, for example, at least one selected from a group consisting of copper, a copper alloy, aluminum, an aluminum alloy, iron, an iron alloy, magnesium, and a magnesium alloy may be used. The specific shape of the metal base material 2 is not particularly limited, and may be formed according to the purpose of use.

### Silver-Tin Alloy Plating Layer 3

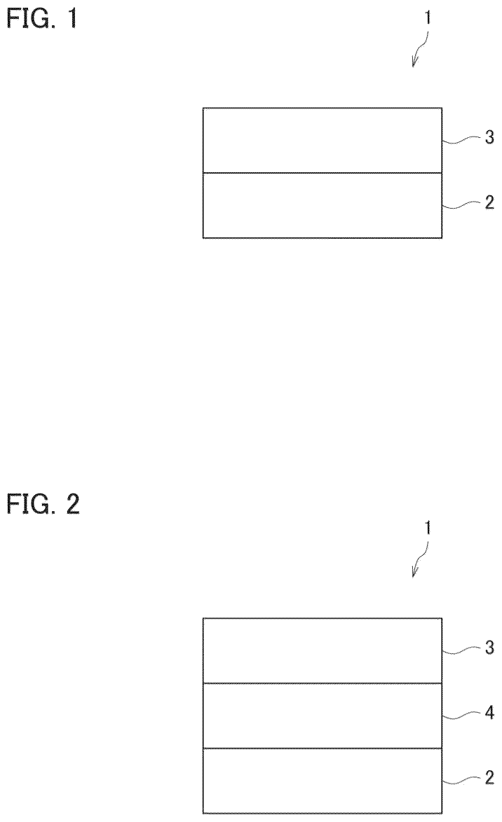

As illustrated in FIG. 1, the silver-tin alloy plating layer 3 is arranged on the metal base material 2. The silver-tin alloy plating layer 3 includes a function of protecting the metal base material 2 from corrosion. In view of corrosion prevention and moldability, the silver-tin alloy plating layer 3 preferably covers the entire metal base material 2.

A content amount of Sn in the silver-tin alloy plating layer 3 is preferably from 26 mass % to 38 mass %. Further, in addition to silver and tin, the silver-tin alloy plating layer 3 preferably contains at least one element selected from a group consisting of In, Zn, Ti, and Sb. When the silver-tin alloy plating layer 3 contains such an element, it can be expected that an intermetallic compound with silver is generated to improve the hardness of the surface of the silver-tin alloy plating layer 3.

The silver-tin alloy plating layer 3 contains an intermetallic compound of silver and tin. Examples of the intermetallic compound of silver and tin include Ag₃Sn and the like. In the present embodiment, when the silver-tin alloy plating layer 3 contains the intermetallic compound, the hardness of the silver-tin alloy plating layer 3 can be improved. Such an intermetallic compound is precipitated by controlling the concentration of silver ions and tin ions in a plating bath. As another intermetallic compound, examples of the intermetallic compound containing at least one element selected from a group consisting of In, Zn, Ti, and Sb in addition to silver and tin include Ag₃In, AgZn, AgTi, and Ag₇Sb.

As illustrated in FIG. 3A, the silver-tin alloy plating layer 3 contains crystal grains of Sn in addition to the above-mentioned intermetallic compound. Further, the ratio of the crystal grains of Sn per observed area is equal to or greater than 2.0% and equal to or less than 11.0% when the cross-section of the silver-tin alloy plating layer is observed with an FE-SEM. The silver-tin alloy plating layer 3 contains the crystal grains of Sn in this state, and hence the crystal grains of Ag₃Sn are prevented from growing in a columnar structure (the example illustrated in FIG. 3B). As a result, as illustrated in FIG. 3A, the crystal grains of Ag₃Sn are arranged isotropically. Note that the reference symbol 60 in FIG. 3A and FIG. 3B indicates the crystal grains of Ag₃Sn, and the reference symbol 70 in FIG. 3A indicates the crystal grains of Sn.

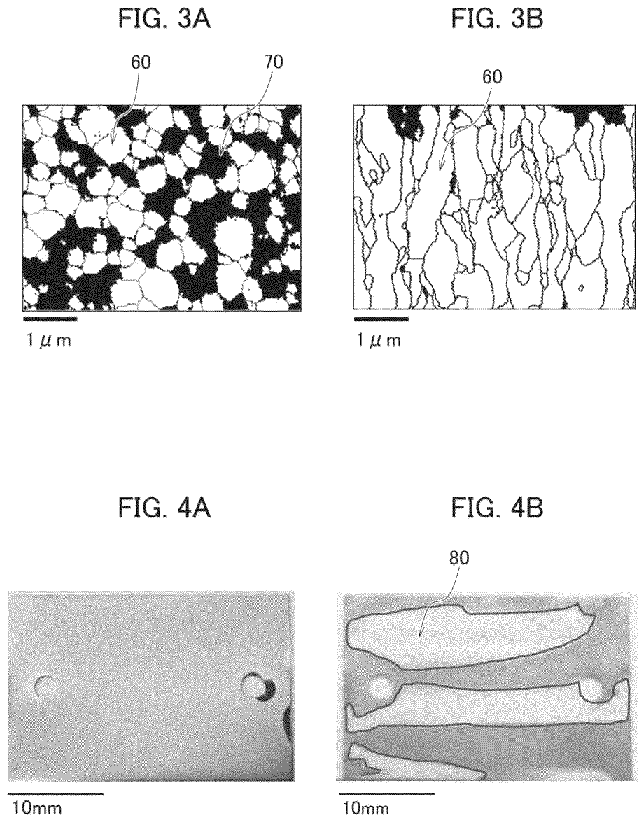

Further, when the crystal grains of Ag₃Sn of the silver-tin alloy plating layer 3 are arranged isotropically, occurrence of Ag migration under high temperature and high humidity environments or after saltwater spray (the example illustrated in FIG. 4B) is suppressed. As a result, as illustrated in FIG. 4A, occurrence of Ag migration is not confirmed. Note that the reference symbol 80 in FIG. 4B indicates a location of the surface of the silver-tin alloy plating layer 3 in which Ag migration occurs.

In view of abrasion resistance, the Vickers hardness of the surface of the silver-tin alloy plating layer 3 in the plating material 1 is preferably equal to or greater than 180 Hv and equal to or less than 310 Hv. Note that the Vickers hardness can be measured according to the Japanese Industrial Standards JIS Z2244: 2009 (Vickers hardness test-Test Method).

In view of corrosion resistance, the thickness of the silver-tin alloy plating layer 3 is preferably equal to or larger than 0.1 μm, more preferably, equal to or larger than 1 μm. Further, in view of productivity and cost reduction, the thickness of the silver-tin alloy plating layer 3 is equal to or smaller than 30 μm, more preferably, equal to or smaller than 20 μm.

For example, a silver-tin alloy plating bath is prepared by mixing tin salt into a silver plating bath, and the metal base material 2 is immersed and plated in the silver-tin alloy plating bath. In this manner, the silver-tin alloy plating layer 3 can be formed. The plating treatment is preferably a constant current electrolysis so that a film thickness is easily controlled.

The silver-tin plating bath used for the silver-tin alloy plating layer 3 may contain silver salt, tin salt, conductive salt, a brightening agent, or the like. For example, the material used as silver salt contains salt of at least one or more types selected from a group consisting of silver cyanide, silver iodide, silver oxide, silver sulfate, silver nitrate, silver methanesulfonate, and silver chloride. Further, the conductive salt contains salt of at least one or more types selected from a group consisting of potassium cyanide, sodium cyanide, potassium pyrophosphate, silver methanesulfonate, potassium iodide, and sodium thiosulfate. Examples of the brightening agent include a metal brightening agent such as antimony, selenium, and tellurium, and an organic brightening agent such as benzenesulfonic acid and mercaptan. Note that, for example, the silver ion concentration in the plating bath is preferably from 30 g/L to 45 g/L.

Examples of the material used for tin salt in the silver-tin alloy plating layer 3 include salt of at least one or more types selected from a group consisting of organic sulfonic acid primary tin such as methanesulfonic acid primary tin, primary tin salt such as pyrolidine acid primary tin, primary tin chloride, primary tin sulfate, primary tin acetate, primary tin sulfamate, primary tin gluconate, primary tin tartrate, primary tin oxide, primary tin borofluoride, primary tin succinate, primary tin lactate, primary tin citrate, primary tin phosphate, primary tin iodide, primary tin glycolate, and primary tin hexafluorosilicate, and secondary tin salt such as tin sodium sulfate and tin potassium sulfate. Note that, for example, the tin ion concentration in the plating bath is preferably from 5 g/L to 9 g/L.

In order to isotropically arrange the crystal grains of Ag₃Sn in the silver-tin alloy plating layer 3, the current density for electroplating the silver-tin alloy plating layer 3 is preferably from 2.0 A/dm² to 7.0 A/dm². The higher current density achieved faster silver-tin alloy plating, thereby enhancing productivity. However, the higher current density tends to result in surface roughness. Therefore, the upper limit of the current density is set to satisfy the condition relating to surface roughness, in consideration of various factors such as productivity, the plating bath composition, the ion concentrations, and the shape of the plated object.

Further, in order to isotropically arrange the crystal grains of Ag₃Sn in the silver-tin alloy plating layer 3, a plating bath temperature at which the silver-tin alloy plating layer 3 is subjected to electroplating is preferably 0° C. to 50° C., more preferably, 20° C. to 36° C. By setting the plating bath temperature to fall within such a range, the silver-tin alloy plating layer 3 can be formed effectively through the complexation effect.

### Foundation Layer 4

As illustrated in FIG. 2, the plating material 1 according to the present embodiment may further include a foundation layer 4 in such a way as to provide various functions. In the present embodiment, the foundation layer 4 is arranged between the metal base material 2 and the silver-tin alloy plating layer 3.

The foundation layer 4 preferably contains metal of at least one or more types selected from a group consisting of nickel, copper, and silver. Specifically, the foundation layer 4 preferably contains metal of at least one or more types selected from a group consisting of nickel, a nickel alloy, copper, a copper alloy, silver, and a silver alloy.

For example, when the foundation layer 4 contains nickel or a nickel alloy, the foundation layer 4 is capable of suppressing diffusion of the elements constituting the metal base material the silver-tin alloy plating layer 3, thereby improving contact reliability and heat resistance. In other words, the foundation layer 4 functions as a barrier layer. The thickness of the foundation layer 4 containing any one of nickel and a nickel alloy is not particularly limited as long as the foundation layer 4 functions as a barrier layer. The thickness is preferably larger than 0 μm and equal to or smaller than 3 μm, more preferably, from 0.1 μm to 1.0 μm.

For example, then the foundation layer 4 contains metal of at least one or more types selected from a group consisting of copper, a copper alloy, silver, and a silver alloy, the adhesion between the metal base material 2 and the silver-tin alloy plating layer 3 can be improved. In other words, the foundation layer 4 functions as a strike plating layer. The thickness of the foundation layer 4 containing metal of at least one or more types selected from a group consisting of copper, a copper alloy, silver, and a silver alloy is not particularly limited as long as the adhesion is improved. The adhesion may be improved even with an extremely thin thickness. Thus, for example, the thickness in this case is preferably larger than 0 μm and equal to or smaller than 3 μm, more preferably, from 0.1 μm to 1.0 μm.

The foundation layer 4 may be a single layer, or may include a plurality of layers. For example, the foundation layer 4 includes a lower layer and an upper layer being arranged on the lower layer. Further, for example, the lower layer of the foundation layer 4 may contain any one of nickel and a nickel alloy, and the upper layer of the foundation layer 4 may contain metal of at least one or more types selected from a group consisting of copper, a copper alloy, silver, and a silver alloy. Thus, for example, a nickel plating layer may be formed as the lower layer of the foundation layer 4, and a silver strike plating layer may be formed as the upper layer of the foundation layer 4. A combination of those layers may be changed as appropriate according to the purpose.

A method of forming the foundation layer 4 is not particularly limited. For example, a plated material being the metal base material 2 may be put into a plating bath, and may be plated by a publicly-known plating method.

The plating material 1 according to the present embodiment includes the metal base material 2 and the silver-tin alloy plating layer 3 being arranged on the metal base material 2 and containing a silver-tin alloy. Further, the silver-tin alloy plating layer 3 contains the crystal grains of Ag₃Sn, and the ratio of the crystal grains of Sn per observed area is equal to or greater than 2.0% and equal to or less than 11.0% when the crystal grains of Ag₃Sn are arranged isotropically, and the cross-section of the silver-tin alloy plating layer is observed with an FE-SEM. Thus, when the plating material 1 according to the present embodiment is used as a terminal, the terminal is excellent in environmental resistance.

### Terminal 10

A terminal 10 according to the present embodiment is formed of the plating material 1. Thus, the terminal 10 according to the present embodiment has higher abrasion resistance while minimizing the increase in contact resistance as compared to a terminal plated with silver or a silver alloy in the related art. Note that, in view of corrosion prevention and moldability, the silver-tin alloy plating layer 3 of the terminal 10 preferably covers the entire metal base material 2 of the terminal 10.

### Terminal-Equipped Electric Wire 20

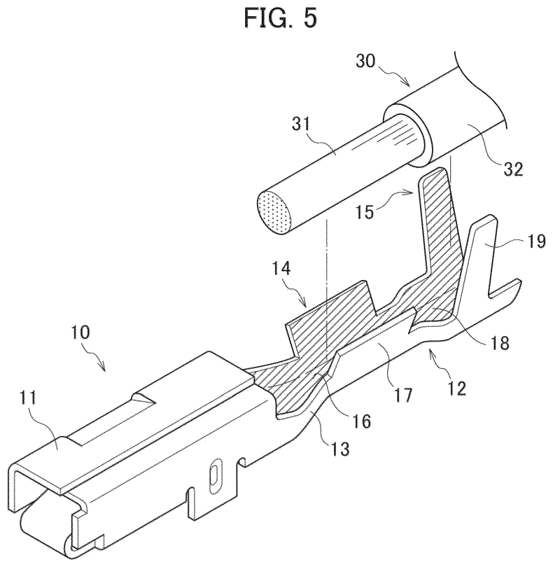

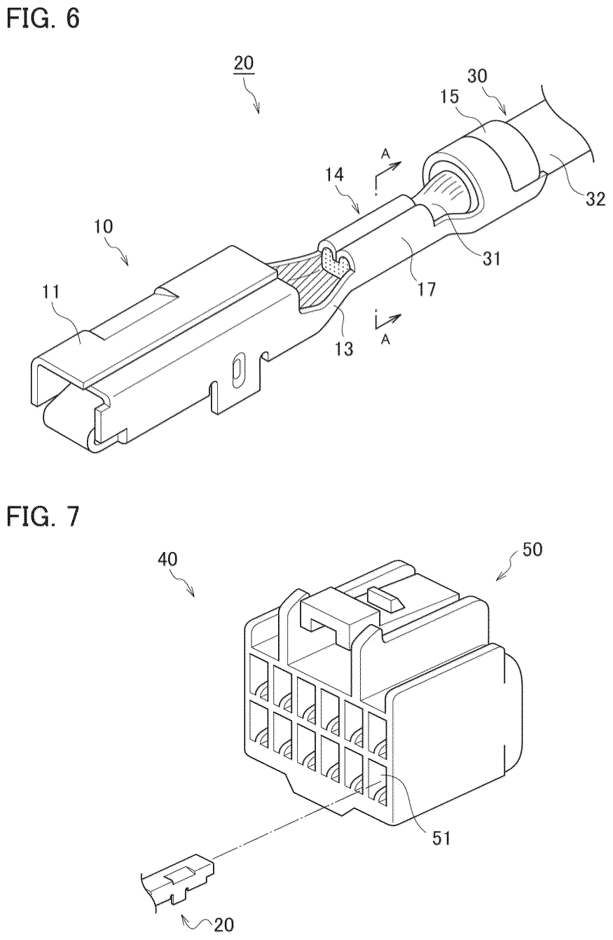

As illustrated in FIG. 5 and FIG. 6, a terminal-equipped electric wire 20 of the present embodiment includes the terminal 10. Specifically, the terminal-equipped electric wire 20 according to the present embodiment includes an electric wire 30 that includes a conductor 31 and an electric wire coating material 32 coating the conductor 31 and the terminal 10 that is connected to the conductor 31 of the electric wire 30 and is formed of the plating material 1. Note that FIG. 5 illustrates a state before the electric wire is crimped with the terminal, and FIG. 6 illustrates a state after the electric wire is crimped with the terminal.

The terminal 10 illustrated in FIG. 5 is a female-type crimp terminal. The terminal 10 includes an electric connection portion 11 that is connected to a mating terminal, which is omitted in illustration. The electric connection portion 11 has a box-like shape, and incorporates a spring piece that is engaged with the mating terminal. Moreover, the terminal 10 is provided with an electric wire connection portion 12 on a side opposite to the electric connection portion 11. The electric wire connection portion 12 is connected to a terminal portion of the electric wire 30 by tightening. The electric connection portion 11 and the electric wire connection portion 12 are connected to each other via a coupling portion 13. Note that the electric connection portion 11, the electric wire connection portion 12, and the coupling portion 13 are formed of the same material and are integrated with one another to form the terminal 10, but are provided with names respectively for the sake of convenience.

The electric wire connection portion 12 includes a conductor crimping portion 14 that tightens the conductor 31 of the electric wire 30 and a coating material tightening portion 15 that tightens the electric wire coating material 32 of the electric wire 30.

The conductor crimping portion 14 directly contacts with the conductor 31 exposed by removing the electric wire coating material 32 of the terminal portion of the electric wire 30, and includes a bottom plate portion 16 and a pair of conductor tightening pieces 17. The pair of conductor tightening pieces 17 are provided to extend upward from both the edges of the bottom plate portion 16. The pair of conductor tightening pieces 17 are bent inward to enfold the conductor 31 of the electric wire 30. With this, tightening can be performed to obtain a state in which the conductor 31 closely contacts with the upper surface of the bottom plate portion 16. With the bottom plate portion 16 and the pair of conductor tightening pieces 17, the conductor crimping portion 14 is formed into a substantially U-like shape in a cross-sectional view.

The coating material tightening portion 15 directly contacts with the electric wire coating material 32 of the terminal portion of the electric wire 30, and includes a bottom plate portion 18 and a pair of coating material tightening pieces 19. The pair of coating material tightening pieces 19 are provided to extend upward from both the edges of the bottom plate portion 18. The pair of coating material tightening pieces 19 are bent to enfold the portion provided with the electric wire coating material 32. With this, tightening can be performed under a state in which the electric wire coating material 32 closely contacts with the upper surface of the bottom plate portion 18. With the bottom plate portion 18 and the pair of coating material tightening pieces 19, the coating material tightening portion 15 is formed into a substantially U-like shape in a cross-sectional view. Note that the portion from the bottom plate portion 16 of the conductor crimping portion 14 to the bottom plate portion 18 of the coating material tightening portion 15 is continuously formed as a commonly shared bottom plate.

The electric wire 30 includes the conductor 31 and the electric wire coating material 32 that coats the conductor 31. As the material of the conductor 31, metal with high conductivity may be used. For example, as the material of the conductor 31, copper, a copper alloy, aluminum, an aluminum alloy, or the like may be used. Note that, in recent years, there has been a demand for weight reduction of the electric wire. Thus, it is preferred that the conductor 31 be formed of aluminum or an aluminum alloy that has a light weight.

As the material of the electric wire coating material 32 for coating the conductor 31, a resin capable of securing electric insulation may be used. For example, as the material of the electric wire coating material 32, an olefin-based resin may be used. Specifically, as the material of the electric wire coating material 32, at least one type selected from a group consisting of polyethylene (PE), polypropylene (PP), an ethylene copolymer, and a propylene copolymer may be a main component. Further, as the material of the electric wire coating material 32, polyvinyl chloride (PVC) may also be a main component. It is preferred that, among those, the material of the electric wire coating material 32 contain polypropylene or polyvinyl chloride as a main component due to its high flexibility and durability. Note that the main component described herein indicates a component contained by 50 mass % or more in the entire electric wire coating material 32.

For example, the terminal 10 can be manufactured in the following manner. First, as illustrated in FIG. 5, the terminal portion of the electric wire 30 is inserted into the electric wire connection portion 12 of the terminal 10. With this, the conductor 31 of the electric wire 30 is placed on the upper surface of the bottom plate portion 16 of the conductor crimping portion 14, and the portion provided with the electric wire coating material 32 of the electric wire 30 is placed on the upper surface of the bottom plate portion 18 of the coating material tightening portion 15. Subsequently, the conductor crimping portion 14 and the coating material tightening portion 15 are deformed by pressing the electric wire connection portion 12 and the terminal portion of the electric wire 30. Specifically, the pair of conductor tightening pieces 17 of the conductor crimping portion 14 are bent inward to enfold the conductor 31, and tightening is performed to obtain a state in which the conductor 31 closely contacts with the upper surface of the bottom plate portion 16. Moreover, the pair of coating material tightening pieces 19 of the coating material tightening portion 15 are bent inward to enfold the portion provided with the electric wire coating material 32, and tightening is performed to obtain a state in which the electric wire coating material 32 closely contacts with the upper surface of the bottom plate portion 18. In this manner, as illustrated in FIG. 6, the terminal 10 and the electric wire 30 can be connected to each other by crimping.

The terminal-equipped electric wire 20 according to the present embodiment includes the terminal 10. Thus, the terminal-equipped electric wire 20 according to the present embodiment has higher abrasion resistance at a portion corresponding to the terminal 10 as compared to a terminal plated with silver or a silver alloy in the related art, and hence the increase in contact resistance can be minimized. Thus, the terminal-equipped electric wire 20 according to the present embodiment can be used suitably even in a location such as a hybrid vehicle or an electric vehicle.

### Wire Harness

A wire harness 40 according to the present embodiment includes the terminal-equipped electric wire 20. Specifically, as illustrated in FIG. 7, the wire harness according to the present embodiment includes a connector 50 and the terminal-equipped electric wire 20.

In FIG. 7, on the back side of the connector 50, a plurality of mating terminal mounting portions, which are omitted in illustration, are provided. Mating terminals, which are omitted in illustration, are mounted to the mating terminal mounting portions. In FIG. 7, on the front side of the connector 50, a plurality of cavities 51 into which the terminal 10 of the terminal-equipped electric wire 20 is mounted are provided. Each of the cavities 51 is provided with a substantially rectangular opening portion so that the terminal 10 of the terminal-equipped electric wire 20 can be mounted thereinto. Moreover, the opening portion of each of the cavities 51 is formed to be slightly larger than the cross-section of the terminal 10 of the terminal-equipped electric wire 20. When the terminal 10 of the terminal-equipped electric wire 20 is mounted into the cavity 51 of the connector 50, the electric wire 30 is drawn out from the back side of the connector 50.

The wire harness 40 according to the present embodiment includes the terminal-equipped electric wire 20. Thus, the wire harness 40 according to the present embodiment has higher abrasion resistance at a portion corresponding to the terminal 10 as compared to a terminal plated with silver or a silver alloy in the related art, and hence the increase in contact resistance can be minimized. Thus, the wire harness 40 according to the present embodiment can be used suitably even in a location such as a hybrid vehicle or an electric vehicle.

The terminal 10, the terminal-equipped electric wire 20, and the wire harness 40 according to the present embodiment are described above. The present embodiment is not limited to the above-mentioned embodiment, and may be used as a charging cable including the terminal 10, for example. Such a charging cable also undergoes repeated insertions and withdrawals in an electric vehicle or the like, and is crimped with an electric wire. Thus, present embodiment including the terminal 10 can be used suitably as a charging cable.

### EXAMPLES

The present disclosure is further described below in detail with Examples and Comparative Examples. However, the present disclosure is not limited to those examples.

First, a metal base material being a plated material was subjected to pre-treatment. Specifically, the metal base material was cleansed with alkaline degreasing, was subjected to acid cleaning involving immersion in 10% sulfuric acid for one minute, and then was rinsed with water. Note that a C1020-1/2H copper plate being specified in JIS H3100: 2012 (Copper and copper alloy sheets, plates and strips) and having a plate thickness of 0.25 mm was used as the metal base material. Further, for evaluation during a mud saltwater sliding test, a test piece obtained by embossing the metal base material to a radius of 1 mm was used.

Next, a nickel plating layer was formed on the metal base material. The nickel plating layer was a lower layer of a foundation layer. Specifically, as described above, the metal base material subjected to pre-treatment was immersed in a plating bath for a nickel plating layer, and was subjected to a constant current electrolysis under conditions of the current density of 10 A/dm², the electrolysis time of two minutes, and the plating bath temperature of 45° C. by using a stabilized DC power supply.

Further, a silver strike plating layer was formed on the nickel plating layer. The silver strike plating layer was an upper layer of the foundation layer, and was capable of improving the adhesion between the nickel plating layer and a silver-tin alloy plating layer. Specifically, the metal base material on which the nickel plating layer was formed was immersed in a plating bath for a silver strike plating layer, and was subjected to a constant current electrolysis under conditions of the current density of 2.5 A/dm², the electrolysis time of one minute, and the plating bath temperature of 25° C. by using a stabilized DC power supply. After the electrolysis, the metal base material was taken out from the plating bath, and was cleansed with water. As a result, the metal base material in which the silver strike plating layer was formed on the entire surface of the metal base material having the nickel plating layer formed thereon was obtained. Note that the composition of the plating bath for a silver strike plating layer was 4.2 g/L of silver cyanide and 80 g/L of potassium cyanide. Further, the thickness of the silver strike plating layer was 0.3 μm. Further, PA18-5B available from TEXIO TECHNOLOGY CORPORATION was used as the stabilized DC power supply.

Further, the silver-tin alloy plating layer was formed on the silver strike plating layer. Specifically, as shown in Table 1, the metal base material having the silver strike plating layer formed thereon was immersed in the plating bath obtained by adjusting the silver ion concentration and the tin ion concentration, and was subjected to a constant current electrolysis by using a stabilized DC power supply. The electrolysis conditions (the current density, the plating bath temperature, the stirring speed and the stirring method) were as shown in Table 1. After the electrolysis, the metal base material was taken out from the plating bath, and was cleansed with water. Note that the electrolysis time was adjusted so that the thickness of the plating layer thus formed was 20 μm. PA18-5B available from TEXIO TECHNOLOGY CORPORATION was used as the stabilized DC power supply.

### Evaluation

The test pieces in Examples and Comparative Examples were subjected to evaluation by the following method. The results are also shown in Table 1.

### Content Amount of Sn in Silver-Tin Alloy Plating Layer

A content amount of Sn in the silver-tin alloy plating layer was confirmed by analyzing the obtained test piece with scanning electron microscope (SEM)—energy dispersive X-ray spectroscopy (EDX).

### Intermetallic Compound of Silver-Tin Alloy Plating Layer

The intermetallic compound of the silver-tin alloy plating layer was confirmed as Ag₃Sn by subjecting the obtained test piece to an X-ray crustal structure analysis by using an X-ray diffractometer (XRD).

### Shape of Crystal Grains of Ag₃Sn

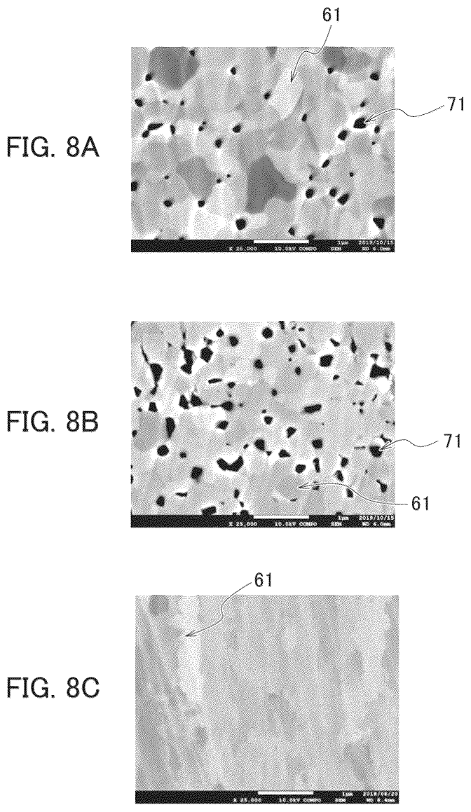

The cross-section (the cross-sectional area of 1 cm²) that was cut out from the obtained test piece was subjected to sample adjustment using ion milling or the like, and the cross-section was observed with an FE-SEM (apparatus name of JSM-7600F available from JEOL Ltd.). The observation results with the FE-SEM are illustrated in FIG. 8. Note that the reference symbol 61 in FIG. 8A, FIG. 8B, and FIG. 8C indicates the crystal grains of Ag₃Sn, and the reference symbol 71 in FIG. 8A and FIG. 8B indicates the crystal grains of Sn. In FIG. 8A and FIG. 8B, it was confirmed that the crystal grains of Sn were contained and the crystal grains of Ag₃Sn were arranged isotropically. Meanwhile, in FIG. 8C, the crystal grains of Sn were not confirmed, and it was confirmed that the crystal grains of Ag₃Sn were arranged in a columnar structure.

### Ratio of Crystal Grains of Sn

The image data obtained from the FE-SEM was imported into the software (OLYMPUS Stream) of a system inverted metallographic microscope (apparatus name of GX51 available from Olympus Corporation). Then, the image data was analyzed through binary processing by using an image editing function. Further, the ratio of the crystal grains of Sn per observed area was calculated from an area ratio of the image.

### Confirmation of Presence or Absence of Ag Migration

The obtained test piece was subjected to a high-temperature and high-humidity test (the temperature of 80° C., the humidity of 90 RH %, the test duration of 100 hours) or a saltwater spray test (the saltwater concentration of 5 wt %, the temperature of 35° C., the test duration of 100 hours). The portion of the sample that turned white after the test was analyzed by using an energy dispersive X-ray spectroscopy (EDS) to confirm presence or absence of Ag migration, as illustrated in FIG. 4A and FIG. 4B.

### Vickers Hardness

The Vickers hardness was evaluated by measuring the surface of the obtained test piece according to JIS Z2244: 2009 by using a micro-hardness tester (apparatus name of DUH-211 available from SHIMADZU CORPORATION). Note that the test temperature was 25° C., and the test force was 5 gf.

### Mud Saltwater Sliding Test

A load variation-type friction and abrasion test apparatus (apparatus name of HHS2000S available from Shinto Scientific Co., Ltd.) was used in the mud saltwater sliding test, and evaluation was performed by the following method. First, quartz glass was used as an opposing material of the test piece obtained through embossing to a radius of 1 mm. The mud saltwater used herein was obtained through adjustment so that each of high-grade sodium chloride (available from KISHIDA CHEMICAL CO., LTD.) and AC dust (ISO12103-1 (2016), A4 (Coarse)) was contained by 5 wt %, and the remainder was distilled water. The test was performed under the test conditions of the load of 2N, the sliding distance of 2 mm, the sliding speed of 5 mm/s, and the sliding times of 300 while 100 μL of the adjusted mud saltwater was supplied every 10 slides. Further, the abrasion mark on the test piece after the test was approximated by an area of a circle, and an abrasion volume was calculated from that area. The evaluation of the mud saltwater sliding test was based on the abrasion volume calculated by the above method. The abrasion volume smaller than the abrasion volume of Ag-2 wt % Sb (828,100 μm³) was classified as “satisfactory”, and the abrasion volume equal to or larger than the abrasion volume of Ag-2 wt % Sb was classified as “poor”.

TABLE 1

| | | | | | | | | Comparative | Comparative |
|---|---|---|---|---|---|---|---|---|---|
| | | | Example 1 | Example 2 | Example 3 | Example 4 | Example 5 | Example 1 | Example 2 |
| Plating bath | Ag ion concentration | g/L | 40 | 35 | 40 | 35 | 35 | 35 | 35 |
| | Sn ion concentration | g/L | 7 | 7 | 7 | 7 | 7 | 7 | 7 |
| Electrolysis | Current density | A/dm² | 1.5 | 3.0 | 2.0 | 1.5 | 1.5 | 0.5 | 1.5 |
| conditions | Plating bath temperature | ° C. | 30 | 36 | 30 | 30 | 36 | 36 | 26 |
| | Stirring speed of stirrer | rpm | 700 | 700 | 700 | 700 | 700 | 700 | 700 |
| Content amount of Sn | | mass % | 26 | 28 | 30 | 35 | 38 | 24 | 40 |
| Shape of crystal grains of Ag₃Sn | | — | Isotropic | Isotropic | Isotropic | Isotropic | Isotropic | Columnar | Isotropic |
| Ratio of crystal grains of Sn per observed area | | % | 2.0 | 4.2 | 4.7 | 9.5 | 10.4 | Absent | 12.0 |
| Presence or | After high-temperature | — | Absent | Absent | Absent | Absent | Absent | Present | Absent |
| absence of | and high-humidity test | | | | | | | | |
| Ag migration | After saltwater spray test | — | Absent | Absent | Absent | Absent | Absent | Present | Absent |
| Vickers hardness | | Hv | 302 | 284 | 246 | 220 | 186 | 292 | 168 |
| Mud saltwater | Abrasion volume | μm³ | 353450 | 314700 | 512680 | 592690 | 784000 | 374000 | 929000 |
| sliding test | Evaluation | — | Satis- | Satis- | Satis- | Satis- | Satis- | Satis- | Poor |
| | | | factory | factory | factory | factory | factory | factory | |

With reference to Table 1, FIG. 8A, and FIG. 8B, with regard to each of the test pieces in Examples 1 to 5, the ratio of the crystal grains of Sn was equal to or greater than 2.0% and equal to or less than 11.0% when the crystal grains of Ag₃Sn were arranged isotropically, and the cross-section of the silver-tin alloy plating layer was observed with the FE-SEM. Further, Ag migration was not confirmed after the high-temperature and high-humidity test or the saltwater spray test. Further, the Vickers hardness was equal to or greater than 180 Hv and equal to or less than 310 Hv, and the result of the mud saltwater sliding test was also satisfactory. Thus, abrasion resistance and environmental resistance were excellent.

With reference to the results in Table 1 and FIG. 8C, with regard to the test piece in Comparative Example 1, the crystal grains of Ag₃Sn were arranged in a columnar structure. Further, with regard to the test piece in Comparative Example 1, Ag migration occurred after the high-temperature and high-humidity test and the saltwater spray test, but the Vickers hardness was equal to or greater than 180 Hv and equal to or less than 310 Hv. The result of the mud saltwater sliding test was satisfactory. Thus, in Comparative Example 1, abrasion resistance was satisfactory, but it cannot be said that environmental resistance was sufficient. Meanwhile, with regard to the test piece in Comparative Example 2, the ratio of the crystal grains of Sn exceeded 11.0% when the cross-section of the silver-tin alloy plating layer was observed with the FE-SEM. Further, the Vickers hardness was less than 180 Hv, and the result of the mud saltwater sliding test was poor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A plating material comprising:
a metal base material; and
a silver-tin alloy plating layer being arranged on the metal base material and containing a silver-tin alloy, wherein
the silver-tin alloy plating layer contains crystal grains of Ag₃Sn, and a ratio of grains of Sn per observed area is equal to or greater than 2.0% and equal to or less than 11.0% when the crystal grains of Ag₃Sn are arranged isotropically, and a cross-section of the silver-tin alloy plating layer is observed with an FE-SEM.

2. The plating material according to claim 1, wherein
a content amount of Sn in the silver-tin alloy plating layer is from 26 mass % to 38 mass %.

3. The plating material according to claim 1, wherein
the Vickers hardness of the surface of the silver-tin alloy plating layer is equal to or greater than 180 Hv and equal to or less than 310 Hv.

4. The plating material according to claim 1, further comprising:
a foundation layer being arranged between the metal base material and the silver-tin alloy plating layer and containing metal of at least one or more types selected from a group consisting of nickel, copper, and silver.

5. A terminal being formed of the plating material according to claim 1.

6. A terminal-equipped electric wire comprising the terminal according to claim 5.

7. A connector comprising the terminal-equipped electric wire according to claim 6.

8. A wire harness comprising the connector according to claim 7.
